(19) United States
(12) Patent Application Publication
(10) Pub. No.: US 2022/0395850 A1
(43) Pub. Date: Dec. 15, 2022

(54) SPRAY GUN

(71) Applicant: ANEST IWATA Corporation, Kanagawa (JP)

(72) Inventor: Atsushi MOROHOSHI, Kanagawa (JP)

(21) Appl. No.: 17/778,930

(22) PCT Filed: Nov. 18, 2020
(86) PCT No.: PCT/JP2020/042940

§ 371 Date: May 23, 2022

(30) Foreign Application Priority Data
Nov. 29, 2019 (JP) 2019-217154

(51) Int. Cl. B05B 12/08; B05B 7/08; B05B 7/12

(52) U.S. Cl. CPC B05B 12/087; B05B 7/08; B05B 7/1254

(57) ABSTRACT

There is provided a spray gun configured to atomize a liquid by using a compressed gas. The spray gun comprises: a gas cap configured to inject the compressed gas; and a liquid nozzle configured to inject the liquid, wherein the gas cap comprises a center gas flow path that has an opening provided in a neighborhood of the liquid nozzle; and multiple pairs of side face gas ports provided outside of the opening, each pair of the side face gas ports being placed at positions symmetric to each other across a center of the liquid nozzle and being directed toward a center in an injecting direction of the liquid nozzle, and wherein control is made to individually regulate a pressure of the gas to be injected from each pair of the side face gas ports.

### TECHNICAL FIELD

The present disclosure relates to a spray gun configured to atomize a liquid such as a paint by a compressed gas and to spray the atomized liquid, so as to coat a coating object or an object to be coated.

### BACKGROUND ART

A spray gun that uses a compressed gas to atomize a liquid such as a paint and form a coated surface has widely been used in a variety of fields. In general, an atomization structure is mainly configured by a liquid nozzle having a liquid injection port and a gas cap having an atomization gas port placed therein. The combination of the liquid injection port and the atomization gas port determines the state that the liquid is atomized and sprayed to coat a coating object or an object to be coated, or more specifically the shape of a spray pattern and the distribution state of sprayed particles.

A typical configuration of the atomization structure is combination of a liquid nozzle that has a liquid injection port formed in a center portion thereof with a gas cap that has a ring-shaped center gas port placed around the liquid injection port. A compressed gas is injected from the gas port provided in the vicinity of the injection port to hit against the liquid injected from the center portion and thereby atomize the liquid. Furthermore, the gas cap includes a pair of protrusions called horn portions on respective outsides thereof; and side face gas ports provided to inject the compressed gas from the horn portions toward the center portion. The compressed gas is sprayed from the respective sides to collide with the sprayed liquid flow at the center portion, so as to form a spray pattern. The side face gas ports are configured to cross at the center of the sprayed liquid flow, such as to press the sprayed liquid flow on the center from the respective side faces. In general, increasing the amount of the gas sprayed from the side face gas ports for the purpose of pressing the injected liquid flow from the respective sides (i.e., enhancing the intensity of the spray) widens the spray pattern. This achieves the desirably high working efficiency when a wide area is to be coated. Restricting and decreasing the amount of the gas sprayed from the side face gas ports (i.e., reducing the intensity of the spray), on the other hand, narrows the spray pattern. This causes the coating object to be coated in a short distance and effectively prevents scattering of the liquid particles.

A disclosed configuration of a gas cap provided for such a spray gun has multiple pairs of side face gas ports that are placed in horn portions to inject the gas from the horn portions toward the center. For example, Patent Document 1 discloses a gas cap having three pairs of side face gas ports placed in horn portions.

Patent Document 2 discloses a spray gun that is basically configured to restrict a ratio of air permeation from a center aperture (center gas port), auxiliary apertures (auxiliary gas outlets), and horn apertures (side face gas ports) of an air nozzle to a range different from the conventional range, so as to achieve spraying in a flatter spray pattern without causing a crack, deformation or the like of the pattern.

### RELATED ART DOCUMENTS

### Patent Documents

Patent Document 1: Japanese Unexamined Patent Publication No. 2006-263594
Patent Document 2: Japanese Unexamined Patent Publication No. 2000-237639

### SUMMARY OF INVENTION

### Technical Problem

The proposed techniques described above, however, do not allow the gas jet flows from the multiple pairs of the side face gas ports provided in the horn portions to be controlled individually. The side face gas ports have fixed diameters and fixed directions. This limits the adjustable range of the width and the shape of the spray pattern to be formed and may not, in many cases, allow the spray pattern to be adjusted according to the size and the surface shape of a coating object or an object to be coated, characteristics of a liquid sprayed for coating, and the like.

An object of the present disclosure is to provide a spray gun configured to adjust a spray pattern according to the size and the surface shape of a coating object or an object to be coated, characteristics of a liquid sprayed for coating, and the like.

### Solution to Problem

In order to achieve the object described above, the present disclosure is implemented as described below.

According to one aspect of the present disclosure, there is provided a spray gun configured to atomize a liquid by using a compressed gas. The spray gun comprises: a gas cap configured to inject the compressed gas; and a liquid nozzle configured to inject the liquid, wherein the gas cap comprises a center gas flow path that has an opening provided in a neighborhood of the liquid nozzle; and multiple pairs of side face gas ports provided outside of the opening, each pair of the side face gas ports being placed at positions symmetric to each other across a center of the liquid nozzle and being directed toward a center in an injecting direction of the liquid nozzle, and wherein control is made to individually regulate a pressure of the gas to be injected from each pair of the side face gas ports.

### BRIEF DESCRIPTION OF DRAWINGS

FIG. 1 is a schematic diagram illustrating the entirety of a spray gun according to one embodiment of the present disclosure:

FIG. 2 is a front view illustrating the spray gun according to the embodiment of the present disclosure;

FIG. 3 is a sectional view illustrating the spray gun according to the embodiment of the present disclosure:

FIG. 4 is a diagram illustrating gas flow paths in the spray gun according to the embodiment of the present disclosure;

FIG. 5 is a diagram illustrating a relationship between the pressure of side face gas flows and the spray pattern; and

FIG. 6 is a diagram illustrating pressure adjustment of the gas injected from the spray gun according to the embodiment of the present disclosure and spray patterns.

### DESCRIPTION OF EMBODIMENTS

The following describes some aspects of the present disclosure (hereinafter referred to as “embodiments”) in detail with referring to accompanied drawings. Throughout the entire description of the embodiments, the like elements are expressed by the like numerals.

In the description below, expressions such as “leading end” and “front” or “forward” are used to represent a position or a direction nearer to or approaching an injection port used to inject a liquid in each of respective members and the like, whereas expressions such as “rear end” and “rear” or “rearward” are used to represent a position or a direction farther from or away from the injection port used to inject the liquid.

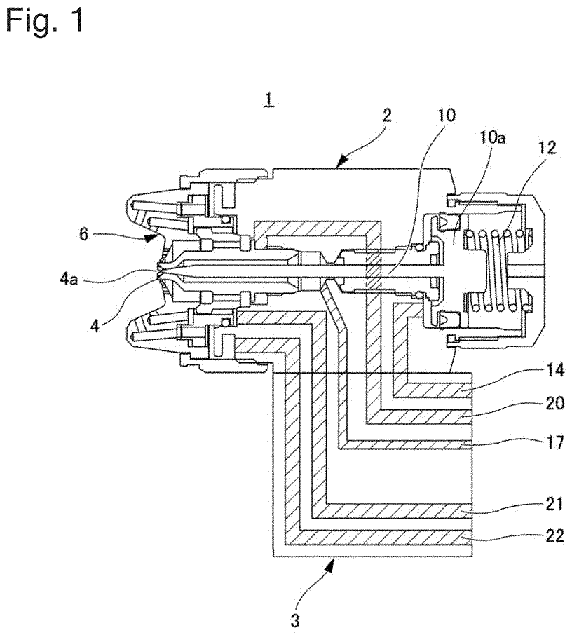

FIG. 1 is a schematic diagram illustrating the entirety of a spray gun 1 according to one embodiment of the present disclosure;

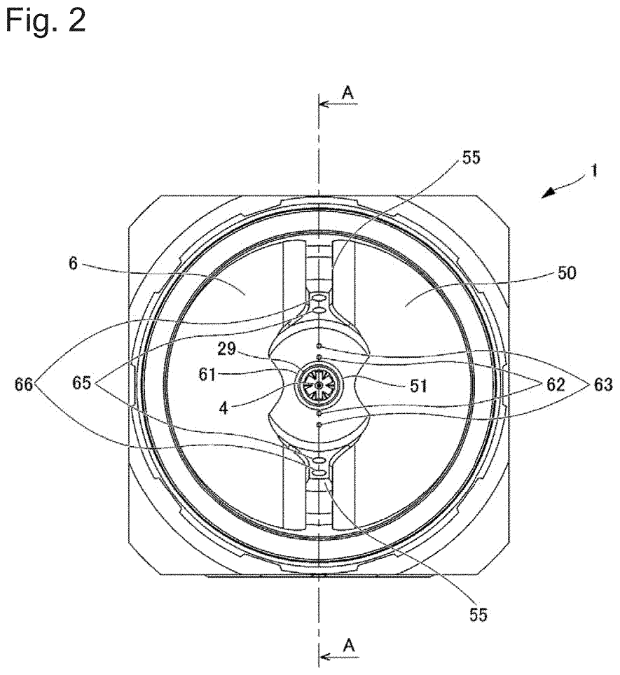

FIG. 2 is a front view illustrating the spray gun 1 according to the embodiment of the present disclosure.

The following describes the general configuration of the spray gun 1 according to the embodiment of the present disclosure with reference to FIG. 1 and FIG. 2.

As shown in FIG. 1, the spray gun 1 according to the embodiment of the present disclosure mainly includes a gun main body 2, a manifold assembly 3, a liquid nozzle 4 and a gas cap 6. In other words, the gun main body 2, the manifold assembly 3, the liquid nozzle 4 and the gas cap 6 constitute a primary part of the spray gun 1. The spray gun 1 according to the embodiment of the present disclosure is called an automatic spray gun by those skilled in the art and is provided with the manifold assembly 3 to collectively consolidate pipe arrangement/connection of a liquid and a gas in a rear portion of the spray gun and thereby facilitate maintenance. The present disclosure is, however, not limited to this type of spray gun.

As shown in FIG. 1, the spray gun 1 according to the embodiment of the present disclosure includes a needle valve 10 provided at a leading end of the liquid nozzle 4 to open and close a liquid injection port 4a; a piston 10a integrated with the needle valve 10; and a needle valve spring 12 provided to continuously bias the needle valve 10 toward the liquid injection port 4a-side.

Accordingly, when no compressed gas is supplied to a piston operating gas flow path 14, the needle valve 10 is biased by the needle valve spring 12 toward the liquid injection port 4a-side provided at the leading end of the liquid nozzle 4. This causes a leading end portion of the needle valve 10 to be inserted into the liquid injection port 4a and close the liquid injection port 4a (state of operation OFF).

When the compressed gas exceeding the biasing force of the needle valve spring 12 is supplied to the piston operating gas flow path 14, on the other hand, the piston 10a moves toward a rear end side of the gun main body 2, and the leading end portion of the needle valve 10 integrated with the piston 10a comes off the liquid injection port 4a, so as to open the liquid injection port 4a. When the liquid is supplied to the liquid injection port 4a, this causes the liquid to be injected from the liquid injection port 4a (state of operation ON).

In the state of operation ON, the gas supplied to a center gas flow path 20, to a first side face gas flow path 21 and to a second side face gas flow path 22 is injected from an atomization gas outlet 61 that is formed as a ring-shaped aperture between an outer circumference of a leading end portion 29 of the liquid nozzle 4 and an opening 51 provided in the vicinity of the liquid nozzle 4 in the gas cap 6, from auxiliary gas outlets 62, from auxiliary gas outlets 63, from first side face gas ports 65 and from second side face gas ports 66, which are shown in FIG. 2.

With a view to preventing insufficient atomization of the liquid, control is made to inject the gas first and to inject the liquid from the liquid injection port 4a subsequently at a timing slightly later than the injection timing of the gas. Such interlocking control is not described in detail here but causes the gas having the pressure regulated by an air pressure reducing valve (not shown) to be supplied to each of the center gas flow path 20, the first side face gas flow path 21, the second side face gas flow path 22, and the piston operating gas flow path 14 via an electromagnetic valve (not shown). The timing of the gas supply by opening and closing the electromagnetic valve is determined, in response to a signal from a control panel (not shown).

The amounts of the gas supply to the first side face gas ports 65 and to the second side face gas ports 66 are independently regulatable by air pressure reducing valves respectively provided in the first side face gas flow path 21 and in the second side face gas flow path 22. A preferable configuration of the air pressure reducing valve enables the amount of the gas supply to be regulated by a remote operation from the control panel.

In use, a liquid supply pipe (not shown) is connected with a liquid supply port 17, and the liquid is supplied from the liquid supply port 17 to a clearance between the liquid nozzle 4 and the needle valve 10.

In response to an ON signal from the control panel, the gas is injected from the atomization gas outlet 61, the auxiliary gas outlets 62, the auxiliary gas outlets 63, the first side face gas ports 65 and the second side face gas ports 66. The liquid is subsequently injected from the liquid injection port 4a provided at the leading end of the liquid nozzle 4.

Almost simultaneously with the injection of the liquid, the injected liquid is microparticulated (atomized) to the state of microparticulate liquid by the gas injected from the atomization gas outlet 61. The microparticulated and atomized microparticulate liquid is adjusted to an elliptical shape pattern by the gas injected from the first side face gas ports 65 and the second side face gas ports 66. The elliptical shape pattern is further fine-adjusted by the gas injected from the auxiliary gas outlets 62 and the auxiliary gas outlets 63.

In response to an OFF signal, the injection of the liquid stops, and the injection of the gas from the atomization gas outlet 61, the auxiliary gas outlets 62, the first side face gas ports 65 and the second side face gas ports 66 stops subsequently. This series of control of the basic operations of the automatic spray gun are not especially complicated, but appropriate adjustment is required on site according to changes in various conditions, such as the supply pressures of the liquid and of the gas and the thicknesses and the lengths of the pipes.

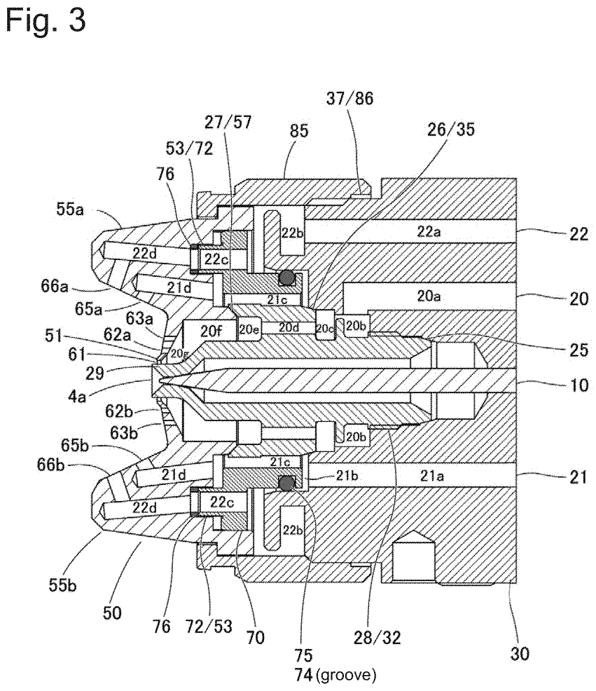

FIG. 3 is a sectional view illustrating the spray gun 1 according to the embodiment of the present disclosure, taken on a line A-A in FIG. 2.

The details of the spray gun 1 according to the embodiment are described with reference to FIG. 2 and FIG. 3.

As shown in FIG. 3, the spray gun 1 includes a main body portion 30, a front portion 50 that is a primary part of the gas cap 6, and a middle portion 70. The nozzle main body 25 is fixed to the main body portion 30 by screwing a male thread 29 of the nozzle main body 25 to a female thread 32 of the main body portion 30. A tapered portion 26 of the nozzle main body 25 closely comes into contact with and adheres to a tapered portion 35 of the main body portion 30. This causes the nozzle main body 25 and the main body portion 30 to be kept gas-tight at this adhering part.

The middle portion 70 and the front portion 50 are further inserted into the main body portion 30. In the middle portion 70, a first seal member 75 that is a seal member such as an O ring is fit in a groove 74, so that the middle portion 70 closely comes into contact with and adheres to the main body portion 30 in such a manner as to prevent leakage of the compressed air. This causes the main body portion 30 and the middle portion 70 to be kept gas-tight at this adhering part. Furthermore, a tapered portion 27 of the nozzle main body 25 closely comes into contact with and adheres to a tapered portion 57 of the front portion 50. This causes the nozzle main body 25 and the front portion 50 to be kept gas-tight at this adhering part.

In the middle portion 70, hollow tubular portions 72 are provided at two positions that are symmetric to each other with respect to a center axis of the nozzle main body 25, and are fit in recesses 53 that are provided in a columnar shape in the front portion 50 corresponding to these tubular portions 72. Second seal members 76 that are seal members used to prevent leakage of the compressed air are inserted into leading end sides of the respective tubular portions 72, so as to closely come into contact with and adhere to the tubular portions 72. This causes the middle portion 70 and the front portion 50 to be kept gas-tight at this adhering part.

A cover 85 is inserted from a front side of the front portion 50, and a male thread 37 of the main body portion 30 is screwed to a female thread 86 of the cover 85. This causes the main body portion 30, the front portion 50, the middle portion 70 and the nozzle main body 25 to be fixed to each other in a closely contact and adhering state.

The following describes a gas flow path in the spray gun 1.

The four gas flow paths, i.e., the center gas flow path 20, the first side face gas flow path 21, the second side face gas flow path 22, and the piston operating gas flow path 14 are formed in the spray gun 1 according to the embodiment of the present disclosure. The gas having the appropriately adjusted pressure is supplied to each of these gas flow paths. The piston operating flow path 14 does not directly affect formation of the spray pattern according to the present disclosure and is thus omitted from the description below.

For the purpose of explanation, FIG. 3 illustrates a flow path 20a, a flow path 21a, and a flow path 22a on an A-A cross section. In fact, however, the flow path 20a, the flow path 21a and the flow path 22a are placed appropriately at different phases with respect to a center axis of the main body portion 30.

The center gas flow path 20 starts from the flow path 20a that is a supply inlet of the compressed gas provided in the main body portion 30, and reaches a flow path 20b that is formed between the main body portion 30 and an outer circumferential face of the nozzle main body 25. The flow path 20b is formed as a flow path over the entire circumference on the outer circumferential face of the nozzle main body 25 and is connected with a flow path 20c. The flow path 20c is distributed to and is connected with flow paths 20d formed by a plurality of through holes provided in the nozzle main body 25, is further connected with flow paths 20e, 20f and 20g that are respectively formed as flow paths over the entire circumference on the outer circumferential face of the nozzle main body 25, and reaches the opening 51 that is a through hole formed in the front portion 50. The leading end portion 29 of the nozzle main body 25 is inserted into the opening 51. The gas reaches the atomization gas outlet 61 that is formed between the opening 51 and an outer circumference of this leading end portion 29, so as to be injected. In the flow path 20c, the tapered portion 26 of the nozzle main body 25 and the tapered portion 35 of the main body portion 30 closely come into contact with and adhere to each other to be kept gas-tight. Similarly, in the flow path 20e, the tapered portion 27 of the nozzle main body 25 and the tapered portion 57 of the front portion 50 closely come into contact with and adhere to each other to be kept gas-tight.

The gas in the flow path 20g reaches the two pairs of the auxiliary gas outlets 62 and the auxiliary gas outlets 63 that are through holes formed on the A-A cross section in the front portion 50 and that are placed symmetric to each other with respect to the center of the leading end portion 29, so as to be injected.

The first side face gas flow path 21 starts from the flow path 21a that is a supply inlet of the compressed gas formed by a through hole provided in the main body portion 30, and reaches a flow path 21b that is formed by a face of the main body portion 30 provided with an outlet of a leading end side of the through hole, the outer circumferential face of the nozzle main body 25 and the middle portion 70. The flow path 21b and a flow path 21c that is connected with the flow path 21b and that is formed by the outer circumferential face of the nozzle main body 25 and the middle portion 70 are provided as flow paths over a fixed range on the outer circumferential face of the nozzle main body 25. The flow path 21c is then distributed to and is connected with two flow paths 21d that are two apertures provided in the front portion 50, and reaches the first side face gas ports 65 to inject the gas therefrom.

The first side face gas ports 65 are provided as one pair of a first side face gas port 65a and a first side face gas port 65b that are formed in one pair of horn portions 55a and 55b provided outside of the opening 51 of the front portion 50 and that are placed at positions symmetric to each other across the center of the liquid nozzle 4 to be directed toward the center in an injecting direction of the liquid nozzle 4.

The first side face gas port 65a and the first side face gas port 65b are placed on the A-A cross section.

The first seal member 75 configured by, for example, an O ring fit in the groove 74 provided in the middle portion 70 comes closely contact with and adheres to the main body portion 30, so that the flow path 21b is kept gas-tight.

The second side face gas flow path 22 starts from the flow path 22a that is a supply inlet of the compressed gas formed by a through hole provided in the main body portion 30, and reaches a flow path 22b that is formed by the main body portion 30 and the cover 85. The flow path 22b is formed over a fixed range on the outer circumferential face of the main body portion 30 and is distributed to and is connected with two flow paths 22c that are formed by through holes provided in the middle portion 70. The flow paths 22c are connected with two flow paths 22d that are apertures formed in the front portion 50, and reach the second side face gas ports 66 to inject the gas therefrom.

The second side face gas ports 66 are provided as one pair of a second side face gas port 66a and a second side face gas port 66b that are formed in the one pair of horn portions 55a and 55b provided outside of the opening 51 of the front portion 50 and that are placed at positions symmetric to each other across the center of the liquid nozzle 4 to be directed toward the center in the injecting direction of the liquid nozzle 4.

The second side face gas port 66a and the second side face gas port 66b are placed on the A-A cross section to be respectively arranged on a front side of the first side face gas port 65a and the first side face gas port 65b.

The flow paths 22c are formed by one pair of the tubular portions 72 that are provided on a forward side of the middle portion 70, and are fit in one pair of the columnar recesses 53 that are provided in the front portion 50. The second seal members 76 inserted into the recesses 53 and respective leading ends of the tubular portions 72 closely come into contact with and adhere to each other, so that the flow paths 22c are kept gas-tight.

As described above, in the spray gun 1, the auxiliary gas outlets 62, the auxiliary gas outlets 63, the first side face gas ports 65 and the second side face gas ports 66 are placed on the A-A cross section that is an identical plane passing through the center axis of the liquid nozzle 4, as shown in FIG. 2. This configuration causes the gas to be injected from the two respective sides toward the center in the injecting direction of the liquid nozzle 4 and thereby causes the injected gas to act from the two respective sides onto the microparticulate liquid that is injected from the liquid nozzle 4 and that is microparticulated (atomized) by the gas injected from the atomization gas outlet 61.

Multiple pairs of or more specifically two pairs of the first side face gas ports 65 and the second side face gas ports 66 are provided as the pairs of side face gas ports to be placed at the positions symmetric to each other across the center of the liquid nozzle 4 and to be directed toward the center in the injecting direction of the liquid nozzle 4.

The pair of the first side face gas ports 65 and the pair of the second side face gas ports 66 are configured such as to allow the pressure of the gas to be controlled individually.

In other words, the first side face gas flow path 21 and the second side face gas flow path 22 are provided individually with the pair of the first side face gas ports 65 and with the pair of the second side face gas flow path 22, respectively. This configuration enables the pressure of the gas in each flow path to be controlled individually for each corresponding pair of the side face gas ports. The pressure of the gas injected from each of the side face gas ports is controlled to be not higher than 0.7 MPa, preferably to be not higher than 0.5 MPa and more preferably to be not higher than 0.3 MPa.

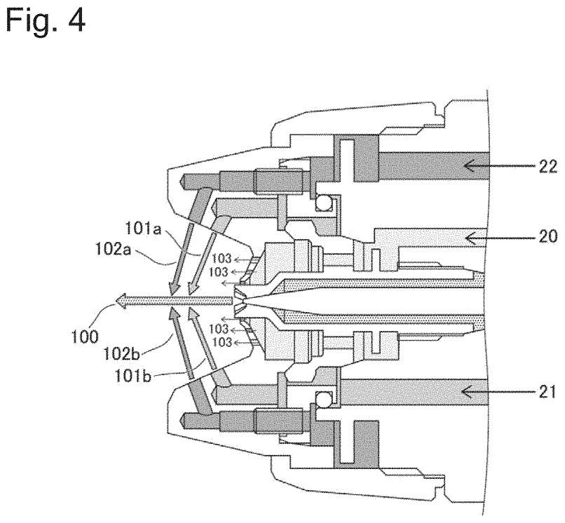

FIG. 4 is a diagram illustrating gas flow paths in the spray gun 1 according to the embodiment of the present disclosure.

The following describes injection of the gas from the spray gun 1 with reference to FIG. 4.

The gas supplied through the center gas flow path 20 is injected from the atomization gas outlet 61 that is provided in the front portion 50 and that is formed in the clearance between the opening 51 and the outer circumference of the leading end portion 29 of the nozzle main body 25. The liquid injected from the liquid injection port 4a provided at the leading end of the liquid nozzle 4 is microparticulated (atomized) by the injected gas to the state of microparticulate liquid. A microparticulate liquid flow 100 is formed by the gas supplied through the center gas flow path 20.

The gas flows formed by the gas supplied through the center gas flow path 20 include auxiliary gas flows 103 sprayed from the auxiliary gas outlets 62 and the auxiliary gas outlets 63, in addition to the microparticulate liquid flow 100. These auxiliary gas flows 103 fine-adjust the spray pattern.

The gas supplied through the first side face gas flow path 21 is injected from the first side face gas port 65a and the first side face gas port 65b that are placed at the positions symmetric to each other with respect to the center of the liquid nozzle 4, toward an identical position on a center axis of the microparticulate liquid flow 100. The first side face gas port 65a and the first side face gas port 65b have an identical inner diameter and have an identical pressure of the gas injected therefrom. First side face gas flows 101 are formed by the gas supplied through the first side face gas flow path 21.

Similarly, the gas supplied through the second side face gas flow path 22 is injected from the second side face gas port 66a and the second side face gas port 66b that are placed at the positions symmetric to each other with respect to the center of the liquid nozzle 4, toward an identical position on the center axis of the microparticulate liquid flow 100. The second side face gas port 66a and the second side face gas port 66 have an identical inner diameter and have an identical pressure of the gas injected therefrom. Second side face gas flows 102 are formed by the gas supplied through the second side face gas flow path 22.

The second side face gas ports 66 are placed on a leading end side of the first side face gas ports 65, and have injection angles set, such that the second side face gas flows 102 hit against the microparticulate liquid flow 100 on a furthermore leading end side than the first side face gas flows 101.

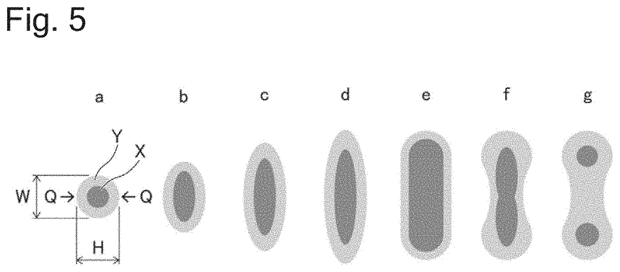

FIG. 5 is a diagram illustrating a relationship between the pressure of side face gas flows and the spray pattern.

A pattern a represents a spray pattern with spraying only the microparticulate liquid flow 100 but without spraying any side face gas flows Q. In the pattern a, an area X denotes a center area where the liquid flow is uniform and has a sufficient amount of the liquid, and an area Y denotes a peripheral area where the liquid flow has an insufficient amount of the liquid. Accordingly, it is important to widen the area X, in order to achieve coating of good quality and high efficiency. This basic configuration of the spray pattern is similarly applied to the following description.

A gradual increase in the intensity of the side face gas flows Q changes the spray pattern from the pattern a to a pattern b, to a pattern c, and further to a pattern d with increasing a width W of the spray pattern. These spray patterns are center-convex spray patterns having larger heights H at the center. These spray patterns have small areas X and are thus not suitable for coating of good quality and high efficiency.

A further increase in the intensity of the side face gas flows Q changes the spray pattern from the pattern d to a pattern e. This pattern e has a uniform height H and a wide area X and is a spray pattern suitable for coating of good quality and high efficiency.

A further increase in the intensity of the side face gas flows Q changes the spray pattern from the pattern e to a pattern f and further to a pattern g. These spray patterns have non-uniform heights H and constrictions and also have narrow areas X and wide areas Y. In the pattern g, the area X is divided into two areas. These spray patterns are not suitable for the coating operation of good quality and high efficiency.

Accordingly, in order to achieve coating of good quality and high efficiency, it is required to form a spray pattern having a uniform height H and a wide area X, like the pattern e.

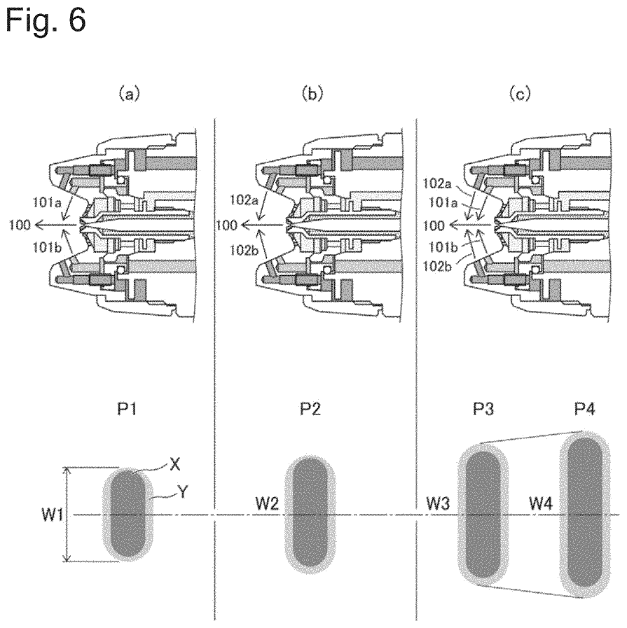

FIG. 6 is a diagram illustrating pressure adjustment of the gas injected from the spray gun 1 according to the embodiment of the present disclosure and spray patterns.

The microparticulate liquid flow 100 and the auxiliary gas flows 103 are employed as common conditions in the description with reference to FIG. 6. The spray pattern to be formed is a spray pattern suitable for coating of good quality and high efficiency and corresponding to the pattern e shown in FIG. 5.

FIG. 6(a) shows a spray pattern P1 with spraying the first side face gas flows 101 but without spraying the second side face gas flows 102 (setting the pressure to 0 MPa). The spray pattern P1 has a width W1.

FIG. 6(b) shows a spray pattern P2 with spraying the second side face gas flows 102 but without spraying the first side face gas flows 101 (setting the pressure to 0 MPa). The spray pattern P2 has a width W2, which is larger than the width W1 of the spray pattern P1.

FIG. 6(c) shows a spray pattern P3 with spraying both the first side face gas flows 101 and the second side face gas flows 102. The spray pattern P3 has a width W3, which is larger than the width W2 of the spray pattern P2.

In this state, further individually adjusting the intensities of the first side face gas flows 101 and the second side face gas flows 102 forms a spray pattern P4 (the intensity balance between the two gas flows is changed by, for example, enhancing the intensity of the second side face gas flows 102 to be higher than the intensity of the first side face gas flows 101). The spray pattern P4 has a width W4, which is further larger than the width W3 of the spray pattern P3.

In the case of coating the liquid, in order to achieve coating of good quality and high efficiency, it is required to make the amount of the liquid in the area X as uniform as possible in the spray pattern as a unit of coating. It is also required to form the spray pattern of the optimum size according to the size and the shape of a coating object or an object to be coated. For example, in the case of coating a coating object having a large plane, the larger width of the spray pattern like the pattern P4 shown in FIG. 6 reduces the frequency of turns at fine pitches. This accordingly assures the uniform coating operation of the less unevenness at a high efficiency.

In the case of a paint that is more likely to cause unevenness, such as a metallic paint, it is important to adjust the spray pattern to be more uniform. Adjusting the spray pattern according to the characteristics and the like of the liquid that is to be sprayed for coating assures the more favorable coating operation.

In the case of a small coating object or small object to be coated, on the other hand, using a large spray pattern like the pattern P4 shown in FIG. 6, which is likely to be larger than the coating object or object to be coated, causes a difficulty in the detailed coating operation. In such a case, decreasing the width of the spray pattern by the control of spraying only the first side face gas flows 101 but not spraying the second side face gas flows 102 like the pattern P1 shown in FIG. 6 assures the favorable coating operation.

As described above, the configuration of the embodiment allows the pressures of the gas to be injected from the first side face gas ports 65 and from the second side face gas ports 66, to be individually controlled for the respective pairs of the first side face gas ports 65 and the second side face gas ports 66. This forms the uniform spray pattern and assures the coating operation of good quality and high efficiency. The configuration of the embodiment also enables the size of the spray pattern to be optimally adjusted according to the shape and the size of the coating object or object to be coated. This provides the spray gun 1 that achieves the coating operation of the better quality and higher efficiency.

Accordingly, there is provided the spray gun 1 configured to adjust the spray pattern according to the size and the surface shape of the coating object or the object to be coated, the characteristics of the liquid to be sprayed for coating and the like.

At least the following aspects are provided from the above description.

(1) According to one aspect, there is provided a spray gun configured to atomize a liquid by using a compressed gas. The spray gun comprises: a gas cap configured to inject the compressed gas; and a liquid nozzle configured to inject the liquid, wherein the gas cap comprises a center gas flow path that has an opening provided in a neighborhood of the liquid nozzle; and multiple pairs of side face gas ports provided outside of the opening, each pair of the side face gas ports being placed at positions symmetric to each other across a center of the liquid nozzle and being directed toward a center in an injecting direction of the liquid nozzle, and wherein control is made to individually regulate a pressure of the gas to be injected from each pair of the side face gas ports. This aspect provides the spray gun configured to adjust a spray pattern according to the size and the surface shape of a coating object or an object to be coated, characteristics of the liquid to be sprayed for coating, and the like.

(2) In the spray gun described in the above aspect (1), a gas flow path may be provided individually with each pair of the side face gas ports.

(3) In the spray gun described in either the above aspect (1) or the above aspect (2), the multiple pairs of the side face gas ports may be arranged on an identical plane that passes through a center axis of the liquid nozzle.

(4) The spray gun described in any of the above aspects (1) to (3) may further comprise a main body portion having a supply port of the compressed gas; a front portion provided with the opening and the side face gas ports; and a middle portion provided between the main body portion and the front portion to connect the gas flow path in the main body portion and in the front portion.

(5) The spray gun described in the above aspect (4) may further comprise a seal member provided in the gas flow path that connects the main body portion with the middle portion or connects the middle portion with the front portion, to prevent leakage of the compressed gas.

(6) In the spray gun described in any of the above aspects (1) to (5), the pressure of the gas to be injected from the side face gas port may be not higher than 0.5 MPa.

(7) In the spray gun described in any of the above aspects (1) to (6), a spray pattern may be adjusted by regulating the pressure of the gas to be injected from each of a plurality of pairs of the side face gas ports.

(8) The spray gun described in any of the above aspects (1) to (7) may comprise a first pair of side face gas ports and a second pair of side face gas ports that are placed on a leading end side of the first pair of side face gas ports, wherein the gas may be injected from the first pair of side face gas ports but may not be injected from the second pair of side face gas ports.

(9) The spray gun described in any of the above aspects (1) to (7) may comprise a first pair of side face gas ports and a second pair of side face gas ports that are placed on a leading end side of the first pair of side face gas ports, wherein the gas may not be injected from the first pair of side face gas ports but may be injected from the second pair of side face gas ports.

(10) The spray gun described in any of the above aspects (1) to (7) may comprise a first pair of side face gas ports and a second pair of side face gas ports that are placed on a leading end side of the first pair of side face gas ports, wherein the gas may be injected from both the first pair of side face gas ports and the second pair of side face gas ports.

(11) There is provided an apparatus for coating, comprising the spray gun described in any of the above aspects (1) to (10); and a pressure regulator placed in each gas flow path that is provided individually with each pair of the side face gas ports, so as to independently regulate the pressure of the gas in each gas flow path.

(12) In the apparatus for coating described in the above aspect (11), the pressure regulator may include an air pressure reducing valve.

Although the present disclosure has been described with reference to some embodiments, it is needless to say that the technical scope of the present disclosure is not at all limited to the scope of the invention described in the above embodiments. As will be understood by those skilled in the art, the above embodiments may be changed, altered, modified or improved in a diversity of ways. It is also clear from the description of the claims that the aspects of such change, alteration, modification or improvement are also included in the technical scope of the invention.

The present application claims priority to Japanese patent application No. 2019-217154 filed on Nov. 29, 1019. The entire disclosure of Japanese patent application No. 2019-217154 filed on Nov. 29, 1019, including the specification, claims, drawings and abstract is incorporated herein by reference in its entirety.

The entire disclosure of Japanese Unexamined Patent Publication No. 2006-263594 (Patent Document 1) and Japanese Unexamined Patent Publication No. 2000-237639 (Patent Document 2), including the specification, claims, drawings and abstract is incorporated herein by reference in its entirety.

### REFERENCE SIGNS LIST

1 spray gun
2 gun main body
3 manifold assembly
4 liquid nozzle
4a liquid injection port
6 gas cap
10 needle valve
10a piston
12 needle valve spring
14 piston operating gas flow path
17 liquid supply port
20 center gas flow path
20a, 20b, 20c. 20d, 20e. 20f, 20g flow paths
21 first side face gas flow path
21a, 21b. 21c, 21d flow paths
22 second side face gas flow path
22a, 22b, 22c. 22d flow paths
25 nozzle main body
26 tapered portion
27 tapered portion
28 male thread
29 leading end portion
30 main body portion
32 female thread
35 tapered portion
37 male thread
50 front portion
51 opening
53 recess
55 (55a, 55b) horn portions
57 tapered portion
61 atomization gas outlet
62 (62a. 62b) auxiliary gas outlets
63 (63a, 63b) auxiliary gas outlets
65 (65a, 65b) first side face gas ports
66 (66a. 66b) second side face gas ports
70 middle portion
72 tubular portion
74 groove
75 first seal member
76 second seal member
85 cover
86 female thread
100 microparticulate liquid flow
101 (101a. 101b) first side face gas flows
102 (102a, 102b) second side face gas flows
103 auxiliary gas flows

1. A spray gun configured to atomize a liquid by using a compressed gas, the spray gun comprising:
a gas cap configured to inject the compressed gas; and
a liquid nozzle configured to inject the liquid, wherein
the gas cap comprises:
a center gas flow path that has an opening provided in a neighborhood of the liquid nozzle; and
multiple pairs of side face gas ports provided outside of the opening, each pair of the side face gas ports being placed at positions symmetric to each other across a center of the liquid nozzle and being directed toward a center in an injecting direction of the liquid nozzle, and wherein
control is made to individually regulate a pressure of the gas to be injected from each pair of the side face gas ports.

2. The spray gun according to claim 1,
wherein a gas flow path is provided individually with each pair of the side face gas ports.

3. The spray gun according to either claim 1,
wherein the multiple pairs of the side face gas ports are arranged on an identical plane that passes through a center axis of the liquid nozzle.

4. The spray gun according to either claim 1, further comprising:
a main body portion having a supply port of the compressed gas;
a front portion provided with the opening and the side face gas ports; and
a middle portion provided between the main body portion and the front portion to connect the gas flow path in the main body portion and in the front portion.

5. The spray gun according to claim 4, further comprising:
a seal member provided in the gas flow path that connects the main body portion with the middle portion or connects the middle portion with the front portion, to prevent leakage of the compressed gas.

6. The spray gun according to either claim 1,
wherein the pressure of the gas to be injected from the side face gas port is not higher than 0.5 MPa.

7. The spray gun according to either claim 1,
wherein a spray pattern is adjusted by regulating the pressure of the gas to be injected from each of a plurality of pairs of the side face gas ports.

8. The spray gun according to either claim 1, comprising:
a first pair of side face gas ports and a second pair of side face gas ports that are placed on a leading end side of the first pair of side face gas ports,
wherein the gas is injected from the first pair of side face gas ports but is not injected from the second pair of side face gas ports.

9. The spray gun according to either claim 1, comprising:
a first pair of side face gas ports and a second pair of side face gas ports that are placed on a leading end side of the first pair of side face gas ports,
wherein the gas is not injected from the first pair of side face gas ports but is injected from the second pair of side face gas ports.

10. The spray gun according to either claim 1, comprising:
a first pair of side face gas ports and a second pair of side face gas ports that are placed on a leading end side of the first pair of side face gas ports,
wherein the gas is injected from both the first pair of side face gas ports and the second pair of side face gas ports.

11. An apparatus for coating, comprising:
the spray gun according to claim 1; and
a pressure regulator placed in each gas flow path that is provided individually with each pair of the side face gas ports, so as to independently regulate the pressure of the gas in each gas flow path.

12. The apparatus for coating according to claim 11,
wherein pressure regulator includes an air pressure reducing valve.
